(19) United States
(12) Patent Application Publication
(10) Pub. No.: US 2018/0127988 A1
(43) Pub. Date: May 10, 2018

(54) HOLLOW-FLOOR ELEMENTS AND METHOD FOR MANUFACTURING A HOLLOW-FLOOR ELEMENT

(71) Applicant: Knauf Gips KG, Iphofen (DE)

(72) Inventors: Jürgen Burczeck, Segnitz (DE); Vladimir Stefanov Tsvetanov, Vidin (BG); Vanya Stancheva Ivanova-Tsaneva, Vidin (BG); Ventzislav Vlahov, Sofia (BG); Elizabeta Amzova, Vidin (BG)

(21) Appl. No.: 15/867,294

(22) Filed: Jan. 10, 2018

Related U.S. Application Data
(63) Continuation of application No. PCT/EP2016/000867, filed on May 25, 2016.

(30) Foreign Application Priority Data
Jul. 15, 2015 (DE) 10 2015 008 916.1
Jul. 21, 2015 (DE) 10 2015 009 280.4

(51) Int. Cl. E04F 15/10; E04F 15/024; B32B 13/04; B32B 13/02; B32B 7/12; B32B 3/06

(52) U.S. Cl. CPC E04F 15/107; E04F 15/02405; B32B 13/04; E04F 15/02038; B32B 7/12; B32B 3/06; B32B 13/02

(57) ABSTRACT

The invention relates to hollow-floor elements for use in a hollow-floor. The hollow-floor elements comprise at least two superimposed load-bearing individual panels, which are firmly joined together. Especially preferably the at least one load-bearing individual panel comprises a gypsum fiberboard. In addition, the invention relates to a method for manufacturing such hollow-floor elements.

### CROSS REFERENCE TO RELATED APPLICATIONS

This application is a continuation of International Application No. PCT/EP2016/000867 filed on May 25, 2016, designating the United States and claiming priority to German patent application DE 10 2015 008 916.1, filed on Jul. 15, 2015, and to German patent application DE 10 2015 009 280.4, filed on Jul. 21, 2015, the entire content of these applications being incorporated herein by reference.

### TECHNICAL FIELD

The invention relates to hollow-floor elements and a method for manufacturing such elements. In particular, the invention relates to hollow-floor panels manufactured preferably from gypsum fibreboards.

### BACKGROUND

Hollow-floor panels (cavity flooring) are known in the art. If a cavity is provided below the walk-on floor level, which is to be utilised for laying pipes and cables, the walk-on floor must have a support structure above the floor of the cavity. Such flooring is generally known as cavity flooring. Sheet-panelled access floors and raised access floors are hollow floors. The essential difference between sheet-panelled access floors and raised access floors consists in the way in which they are installed and in the size of their individual panels.

A raised access floor consists of individual elements which are easy to handle, and which at their edges or even at the corners rest on a support structure. Individual elements are connected with each other in a detachable or non-detachable manner. With sheet-panelled access floors, on the other hand, individual elements are connected among each other forming a contiguous floor body. Individual elements may be connected, for example, by means of a tongue-and-groove system, wherein a fixed connection may be achieved by screwing and/or gluing. In the case of sheet-panelled access floors individual elements are fixedly installed and can no longer be removed again. As a rule, individual elements of sheet-panelled access floors are twice as large as individual elements of raised access floors.

Since with sheet-panelled access flooring individual elements can no longer be removed without a great deal of effort and expense, these hollow floors have access hatches in order to cater for maintenance work to pipes or cables installed below the floor. The access hatches are normally provided in individual elements as recesses with a closable lid.

A raised access floor is different from a sheet-panelled access floor in that it not only contains individual access hatches but in that all individual elements can in principle be removed again individually after the floor has been laid, in order to allow access to the cavity below the floor. Therefore, access hatches are not necessary.

So as to ensure that individual elements can be removed as easily as possible, individual elements are usually supported only in their corner and/or edge areas by the sub-structure. The support surface of individual elements is therefore very small, but it must nevertheless withstand heavy loads placed on it by for example heavy pieces of furniture. Therefore, floor panels which are suitable for such raised access floors must comprise extremely high stability, i.e., be sufficiently robust and resistant to mechanical stresses in compliance with EN 12825.

Hollow-floor panels or individual elements of the hollow floor may be manufactured from several materials, for example from gypsum fibreboard. Gypsum fibreboards may be produced in several ways, i.e., by means of a so-called dry, semi-dry or wet process.

The stability of gypsum fibreboards can be generally increased in three different ways, i.e., the strength/thickness of the panels can be increased; the density of the panels can be increased; the panels may contain reinforcing materials.

If dry or semi-dry processes are used for the manufacture of gypsum fibreboards, increasing the strength/thickness of the panels, however, is limited. When using the dry process, this is started by laying a carpet of dry fibres and dry calcium sulphate material (usually calcium sulphate semi-hydrate). This carpet is smoothed and sprayed with/soaked in the liquid constituents, mainly water and additives. Water is necessary for setting the gypsum, i.e., for converting the semi-hydrate into dihydrate. In order to achieve sufficient formability and a thorough soaking of the material, an excess of water is employed during the manufacture. This excess of water is sucked off to the fullest extent possible through the fibre gypsum carpet as it sets, the carpet is compressed into a panel shape and then dried.

The method steps of soaking the semi-hydrate fibre carpet and of sucking off the surplus water limit the thickness of the panels, which can be produced by this process. The water must be able to soak the carpet right through, and a large proportion of the excess water must be able to be syphoned off in a relatively short time. Therefore, for the process to be economical, the thickness of the carpet is limited.

A further problem occurs when the soaked gypsum fibre carpet is subsequently compressed. Since the fibres are not laid in an oriented manner but essentially randomly, compression of the carpet is economically viable only up to a certain panel thickness. Normally, if the panels are manufactured by the dry or semi-dry process, the maximum panel thickness is 25 mm. This thickness is not sufficient, however, for manufacturing sufficiently stable panels for use, in particular, in raised access flooring. The minimum breaking load required for double-floor panels has been laid down in the standard DIN EN 12825 and is divided into six element classes. Class 1 stipulates a breaking load of larger than 4 kN; class 6 stipulates a breaking load of larger than 12 kN.

The DIN EN 13213 regulates the minimum requirements for sheet-panelled access floors correspondingly.

### SUMMARY

The requirement of the invention consists in providing hollow-floor elements, in particular gypsum fibreboards, which are manufactured by the dry or semi-dry process.

The requirement is met by a hollow-floor element, which consists of at least two load-bearing individual panels, which when placed on top of each other are firmly joined together.

A hollow-floor element according to the invention may be either a sheet-panelled access floor panel for a contiguous hollow floor or a double-floor panel for a raised access. floor.

It is particularly advantageous if the superimposed individual panels of the hollow-floor element are bonded, interlocked or screwed to each other. In principle all types of individual panels known in the art, which are suitable for use in hollow flooring or raised access flooring, may be used. These may be, for example, gypsum fibreboards, laminated boards, cement-bonded fibre panels or cement-bonded laminated panels. Provision is also made according to the invention for different panel types to be combined with each other. Preferably, however, at least one individual panel consists of a gypsum fibreboard.

A load-bearing individual panel is understood to be a panel, which essentially contributes to the stability of the panel and, mainly for this reason, i.e., for the creation of sufficient stability, is integrated with the hollow-floor element. In contrast thereto, hollow-floor elements may have coatings, which, for example, are applied to a hollow-floor element for reasons of optical appearance and/or for ensuring sufficient resistance to abrasion/chemical resistance. Such coatings are not to be understood as load-bearing individual panels in terms of the invention. But coatings may of course be applied additionally to a hollow-floor element according to the invention or may additionally exist.

The requirement is furthermore met by a method for the manufacture of hollow-floor elements comprising at least two superimposed load-bearing individual panels, wherein the at least two load-bearing panels are firmly connected with each other. Preferably individual panels are connected with each other by means of gluing, interlocking and/or screwing.

The invention is particularly helpful in cases in which the manufacture of the hollow-floor element is limited as regards the thickness of the panels. If one of the load-bearing panels is, e.g., a gypsum fibreboard, which has been produced by way of a dry process or semi-dry process, this panel, according to the present state of the art, can be produced with a thickness of max. approx. 25 mm in order to give it sufficient strength. Therefore, a preferred embodiment of the invention comprises load-bearing individual panels with a thickness of between 9 and 25 mm. Gypsum fibreboards of this thickness can be produced in known plants without problems by way of a dry process or semi-dry process. There is no need for a retrofit.

It is, of course, also possible to firmly connect gypsum fibreboards with each other, which are produced by means of a wet process. Admittedly, these gypsum fibreboards can be produced in greater thicknesses than those which are produced by way of a dry or semi-dry process. However, applications come to mind in which even this greater thickness does not provide sufficient stability and a firm connection of the panels could solve this problem. Besides, the manufacture of thin panels is more economical than the manufacture of thick panels, wherefore connecting individual panels is more economical. The same is true, of course, for panels which are not gypsum fibreboards. These panels can also be advantageously firmly connected with each other in order to achieve sufficient stability in the overall bond.

It is particularly preferred if the at least two individual panels of the hollow-floor element are connected offset from each other. For example, the two individual panels can be connected with each other in such a way that none of the edges of the superimposed panels finishes flush with the edges of the respectively other individual panel. Preferably, the edges of the respective individual panels extend however parallel to each other, and the offset of the panels relative to each other is defined. These results in a kind of tongue-and-groove system, which makes it easier to connect a number of hollow-floor elements to form a hollow-floor or a raised access floor.

If the load-bearing individual panels are made from gypsum fibreboard, the following composition comprising at least the below-mentioned constituents, is preferred, i.e., a gypsum matrix with cellulose fibres and glass fibres.

Especially preferably, the gypsum matrix consists of 100% by weight or approx. 100% by weight of dihydrate. Approx. 100% by weight means that only residual amounts of semi-hydrate, e.g., max. 5% by weight, may be present in the individual panel, after it is set. The gypsum matrix is obtained during manufacture from 60 to 100% by weight β-semi-hydrate and 0 to 40% by weight α-semi-hydrate, relative to the total amount of calcium sulphate: The α-semi-hydrate is added in order to improve the dehydration of the calcium sulphate fibre carpet, α-semi-hydrate normally comprises larger crystals than β-semi-hydrate. The α-semi-hydrate crystals are extremely stable against grain decay when coming into contact with water, β-semi-hydrate by contrast is very susceptible to grain decay when coming into contact with water. The use of α-semi-hydrate permits the removal by suction of a large proportion of the excess water by a filter belt, which is not required for converting the semi-hydrate into dihydrate. Its purpose is therefore to improve dehydration. This dehydration improver is instrumental in achieving a higher raw density and thickness of the panel, which in turn improves the stability of the finished panel.

According to a further preferred embodiment of the invention one gypsum fibre panel comprises cellulose fibres in an amount of 1 to 25% by weight, preferably 5 to 15% by weight and chopped glass fibres in an amount of 0.5 to 15% by weight, preferably 0.5 to 10% by weight and especially preferably 0.5 to 5% by weight, wherein the weightings refer to the mass of the mixture of all constituents. The glass fibres preferably have a length of 5 to 25 mm, preferably from 5 to 15 mm.

Such a load-bearing individual panel is therefore manufactured from a mixture, comprising at least β-semi-hydrate, α-semi-hydrate as required, cellulose fibres, glass fibres and water. Preferably the mixture for manufacturing a load-bearing individual panel contains β-semi-hydrate in an amount of 60 to 100% by weight, especially preferably 80 to 95% by weight, α-semi-hydrate in an amount of 0 to 40% by weight, especially preferably 5 to 20% by weight, with reference to the total amount of calcium sulphate, respectively. The cellulose fibres are preferably present in an amount of 1 to 25, especially preferably 5 to 15% by weight with reference to the total amount of the dry mixture.

The glass fibres give additional toughness and stability to the gypsum fibreboard. The glass fibres may, for example, be chopped glass fibres, which are supplied in bunches of great length, also called rowing strands, which are chopped on site. What is essential for the manufacture of a bending-resistant and tension-resistant gypsum fibreboard, is the homogenous mixture of the dry constituents. The glass fibres must be chopped as required and then separated since they are functionally fully effective in the gypsum matrix only, if they have been separated.

In addition to the described constituents commonly used additives such as retarders, rheology additives and similar can be added, which are known to the expert.

### BRIEF DESCRIPTION OF THE DRAWINGS

The invention will now be explained in detail with reference to exemplary embodiments, in which:

FIG. 1 shows a top view of a sheet-panelled access floor element;

FIG. 2 shows a cut-out from a sheet-panelled access floor;

FIG. 3 shows a top view of a double-floor element; and

FIG. 4 shows a cut-out from a double-floor.

### DESCRIPTION OF EXEMPLARY EMBODIMENTS

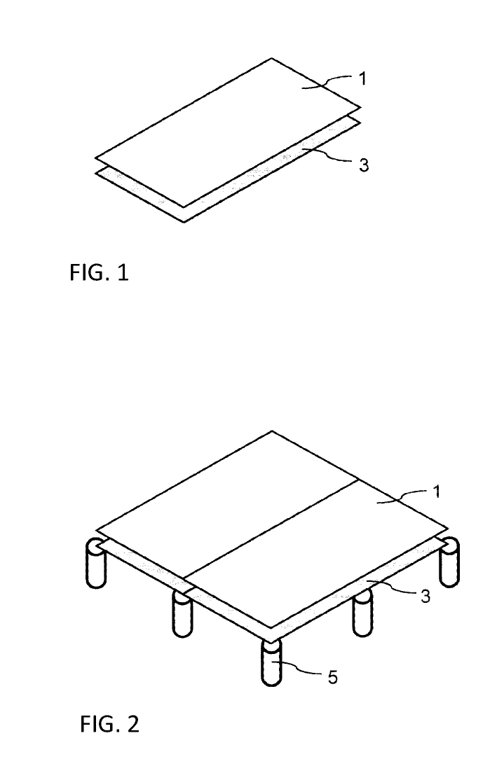

FIG. 1 shows a top view of a hollow-floor element, in this case a sheet-panelled access floor element, which consists of one first load-bearing panel 1 and one second load-bearing panel 3. Both individual panels 1, 3 are laid on top of each other and firmly joined together. The fixed connection is preferably accomplished by gluing the two individual panels together. It is, however, possible to use other ways of connecting the two panels such as by screwing, interlocking or other means known to the expert.

In this case the two load-bearing elements 1, 3 are gypsum fibreboards. It is of course also possible to produce a hollow-floor element from two or more panels of different materials firmly joined together.

The two individual panels 1, 3 are superimposed and offset from one another. Due to the offset a defined overhang is produced on the longitudinal and/or the transverse sides of the hollow-floor element. This offset can be used for joining individual hollow-floor elements in a kind of tongue-and-groove joint together, thereby forming a contiguous floor.

FIG. 2 shows a cut-out from a sheet-panelled access floor, where the hollow-floor elements of FIG. 1 are joined together in a kind of tongue-and-groove system. Individual hollow-floor elements are resting with their lower corners and edges on supports 5.

The gypsum fibreboards, which are used for manufacturing the hollow-floor elements shown in FIGS. 1 and 2 each are 18 mm thick. This results in an overall thickness of 36 mm of the finished hollow-floor elements. The individual panels are manufactured by means of the dry process.

Individual panels are manufactured by mixing the following dry constituents together: β-semi-hydrate 80% by weight with reference to the total calcium sulphate content, α-semi-hydrate 20% by weight with reference to the total calcium sulphate content, cellulose fibres 9% by weight with reference to all dry constituents, and glass fibres 3% by weight with reference to all dry constituents, length: 8 mm

Two individual panels manufactured from this mixture are respectively arranged on top of each other and glued together. The hollow-floor elements produced in this way have a breaking load of >6 kN, tested in accordance with DIN EN 13213.

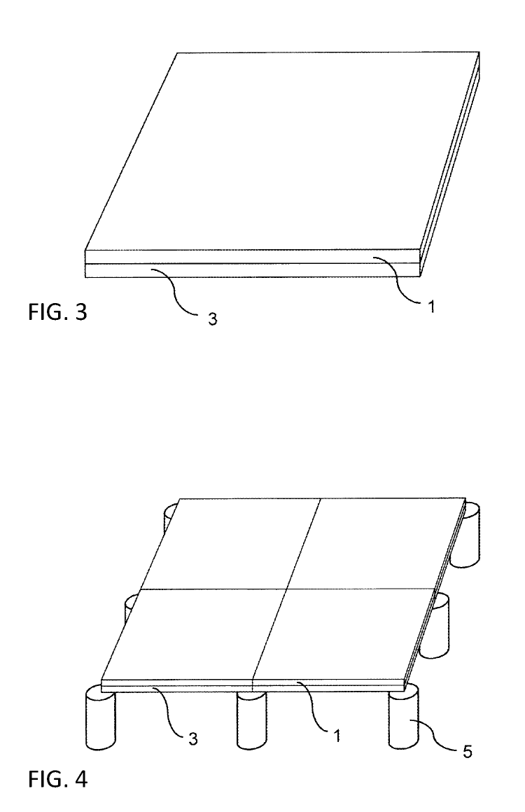

The same material was used to manufacture a double-floor element, which also consists of two individual panels 1, 3 firmly joined together, see FIGS. 3, 4. In contrast to the sheet-panelled access elements shown in FIGS. 1 and 2 the double-floor elements are square-shaped. In order to remove them again at any time from the finished floor without efforts, the panels have smoothly polished slightly chamfered edges such that the floor surface comprises a bigger area than the floor lower surface. The individual panels 1, 3 lie flush on top of each other.

The term “comprising” (and its grammatical variations) as used herein is used in the inclusive sense of “having” or “including” and not in the exclusive sense of “consisting only of.” The terms “a” and “the” as used herein are understood to encompass the plural as well as the singular.

All publications, patents and patent applications cited in this specification are herein incorporated by reference, and for any and all purposes, as if each individual publication, patent or patent application were specifically and individually indicated to be incorporated by reference. In the case of inconsistencies, the present disclosure will prevail.

1. A hollow-floor element for use in a hollow floor, wherein the hollow-floor element comprises at least two superimposed load-bearing individual panels which are firmly joined together.

2. The hollow-floor element according to claim 1, wherein the load-bearing individual panels have a thickness of between 9 and 25 mm.

3. The hollow-floor element according to claim 1, wherein at least one of the load-bearing individual panels is a gypsum fibreboard.

4. The hollow-floor element according to claim 3, wherein the at least one load-bearing individual panel comprises a gypsum matrix with cellulose fibres and glass fibres.

5. The hollow-floor element according to claim 4, wherein the at least one individual panel comprises cellulose fibres in an amount of 1 to 25% by weight and chopped glass fibres in an amount of 0.5 to 15% by weight, wherein the weightings refer to the mixture of all constituents.

6. The hollow-floor element according to claim 4, wherein the glass fibres have a length of between 5 and 25 mm.

7. The hollow-floor element according to claim 1, wherein the individual panels are manufactured by means of a dry process or a semi-dry process.

8. The hollow-floor element according to claim 1, wherein the at least two individual panels are joined firmly together offset from each other.

9. A method for manufacturing a hollow-floor element comprising at least two load-bearing individual panels, wherein the at least two load-bearing individual panels are superimposed and firmly joined together.

10. The method according to claim 9, wherein at least one of the load-bearing individual panels is a gypsum fibreboard, which is manufactured by means of a dry process or semi-dry process.

11. The method according to claim 10, wherein the at least one load-bearing individual panel is manufactured from a mixture, comprising at least β-semi-hydrate, α-semi-hydrate as required, cellulose fibres, glass fibres, and water.

12. The method according to claim 10, wherein the mixture for manufacturing the load-bearing individual panel comprises β-semi-hydrate in an amount of 60 to 100% by weight, α-semi-hydrate in an amount of 0 to 40% by weight, with reference to the total amount of the calcium sulphate.

13. The method according to claim 11, wherein cellulose fibres in an amount of 1 to 25% by weight and chopped glass fibres in an amount of 0.5 to 15% by weight with reference to the mixture of all dry constituents are added to the mixture for manufacturing the at least one load-bearing individual panel.

14. The method according to one of claim 9, wherein the at least two individual panels are firmly joined together offset from each other.

15. The hollow-floor element according to claim 1, wherein the at least two superimposed load-bearing individual panels are glued together.

16. The method for manufacturing a hollow-floor element according to claim 9, wherein the at least two load-bearing individual panels are superimposed and firmly joined together by gluing.

17. The method according to claim 13, wherein the chopped glass fibres have a length of between 5 and 25 mm.
